(19) United States
(12) Patent Application Publication
(10) Pub. No.: US 2014/0110918 A1
(43) Pub. Date: Apr. 24, 2014

(54) OVERLOAD INDICATOR

(71) Applicant: CEQUENT PERFORMANCE PRODUCTS, INC., Plymouth, MI (US)

(72) Inventor: Richard W. McCoy, Granger, IN (US)

(21) Appl. No.: 13/826,143

(22) Filed: Mar. 14, 2013

Related U.S. Application Data
(60) Provisional application No. 61/717,693, filed on Oct. 24, 2012.

(51) Int. Cl. B60D 1/24; G01N 3/08; B60D 1/06

(52) U.S. Cl. CPC B60D 1/248; B60D 1/06; G01N 3/08
USPC 280/511; 116/212; 340/431

(57) ABSTRACT

An overload indicator is shown and described. The overload indicator may include a compression ring located between a portion of a hitch and a hitch ball, the compression ring calibrated to withstand up to a selected vertical force limit. The compression ring collapsing or flattening when applied with a force equal to or greater than the selected vertical force limit.

### CROSS-REFERENCE TO RELATED APPLICATION

This application claims benefit from U.S. Provisional Application Ser. No. 61/717,693, entitled “Overload Indicator” filed on Oct. 24, 2012, which is hereby incorporated in its entirety by reference.

### FIELD OF THE INVENTION

This application relates to an overload indicator and more particularly to a towing assembly overload indicator.

### BACKGROUND

Many vehicles are designed to transport freight, goods, merchandise, personal property, and other such cargo. Often, such vehicles may be arranged to tow a trailer or other towed vehicle by attaching the trailer or other towed vehicle to the towing vehicle, such as through the use of a hitch assembly. The towing industry has developed a number of different types of hitch assemblies, many of which are used for specific towing requirements.

There are many different types of trailer hitches in the art that may be attached to the towing vehicle in a variety of ways, depending on the type of hitch. Some of the most common types of hitches include gooseneck, fifth wheel, front mount, and the like. Typically, trailers may be connected to the towing vehicle by way of a hitch assembly including a ball hitch or member secured to the towing vehicle and a ball socket coupling mechanism on the towed vehicle or trailer that mounts over the ball and thereby allows for the trailer to pivot behind the towing vehicle.

Numerous types of hitch balls have been developed to be attached to the bumper or other rear portion of a towing vehicle. The trailer or towed vehicle may be equipped with a coupler mechanism to attach to the towing vehicle by placing the coupler mechanism over the hitch ball and securing the coupler to the hitch ball. Similar apparatuses using hitch receivers attached to the rear of the towing vehicle and drawbars may be used to secure trailers to towing vehicles.

There are generally two arrangements for securing a trailer to the bed of a towing vehicle—a fifth wheel hitch and a gooseneck ball hitch. A gooseneck hitch may be utilized with a towed vehicle having a gooseneck coupler coupled to a gooseneck ball located in the bed of the towing vehicle. The gooseneck ball is either permanently or selectively secured to the frame or bed of the towing vehicle.

The gooseneck coupler to gooseneck ball connection may allow for more relative movement between the towing vehicle and the towed vehicle as the towing vehicle makes turns, traverses uneven or rough terrain, and passes along inclining and declining roadways. The gooseneck ball member may be removed or lowered to a stowed position below the bed to ensure that the use of the bed is not substantially hindered by the presence of the gooseneck ball.

The gooseneck coupler typically includes a manually operated clamping arrangement that retains the gooseneck ball member in the socket and thus the towed vehicle to the towing vehicle. Generally, the gooseneck coupler may be secured to the tongue of the towed vehicle, usually a forward extension of the frame.

Some trailers are designed to carry heavy loads. When a trailer load is heavy as compared to the weight of the towing vehicle, applying the trailer load over or otherwise in close proximity to the rear axle of the towing vehicle may create preferable towing condition. In addition, such an arrangement may put much of the force of the trailer load onto structural members of the towing vehicle, such as the frame, whereby the hitch ball may be located in the truck bed. However, the towing vehicle may have weight limit and if that weight limit is surpassed the truck may be considered overloaded.

The most common means of overloading a vehicle is from vertical force. Current vehicles used with goosenecks may overload either the truck axle or the hitch rating without any indication to the user that they have done so. Without any indication of an overload a person may continue to overload the vehicle creating damage or shorter life to the rear axle, hitch, truck frame, suspension or axle.

Therefore, there is a need for a reliable gauge or indicator that identifies when a potential overloaded conditions occurs. There is also a need for this gauge or indicator to be affordable, easy to use and effective at indicating the overload condition of the towing vehicle coupled to the towing vehicle.

### SUMMARY

An overload indicator is shown and described. The overload indicator may include a compression ring located between a portion of a hitch and a hitch ball, the compression ring calibrated to withstand up to a selected vertical force limit. The compression ring collapsing or flattening when applied with a force equal to or greater than the selected vertical force limit.

An overload indicator may include a load cell selectively positioned between a hitch ball and a hitch assembly, where the load cell measures a vertical force applied to at least one of the hitch ball and hitch assembly. The overload indicator may also include a microcontroller operatively coupled with the load cell, where the load cell provides an input signal to the microcontroller indicative of the vertical force measured.

A hitch ball assembly may include a ball member configured to operatively engage a socket of a hitch assembly and a hitch ball flange extending from the ball member. The hitch ball assembly may also include an overload indicator positioned between the hitch assembly and the hitch ball flange, where the overload indicator is calibrated to identify when a force equal to or greater than a selected vertical force limit is applied to the overload indicator.

### BRIEF DESCRIPTION OF THE DRAWINGS

Operation of the invention may be better understood by reference to the following detailed description taken in connection with the following illustrations, wherein:

FIG. 1 is a cross-sectional view of a calibrated overload indicator in an uncompressed state selectively attached between a hitch ball and a gooseneck hitch receiver.

FIG. 2 is a cross-sectional view of the calibrated overload indicator in a compressed state selectively attached between the hitch ball and the gooseneck hitch receiver.

FIG. 3 is a perspective view of the calibrated overload indicator of FIG. 1.

FIG. 4 is a cross-sectional view of an electrical overload indicator selectively positioned between a hitch ball and gooseneck hitch receiver.

FIG. 5 is a cross-sectional view of an electrical overload indicator selectively positioned between a hitch ball and gooseneck hitch receiver.

FIG. 6 is a top view of embodiments of a compression ring having a plurality of waves or undulations.

FIG. 7 is a cross-sectional view of the compression ring of FIG. 6 along line 7-7.

FIG. 8 is a top view of embodiments of a compression ring having a generally flat lower surface while having a top surface comprising a plurality waves or undulations.

FIG. 9 is a cross-sectional view of the compression ring of FIG. 8 along line 9-9.

FIG. 10 is a top view of embodiments of a compression ring having a plurality of thin radially oriented ribs.

FIG. 11 is a cross-sectional view of the compression ring of FIG. 10 along line 11-11.

FIG. 12 is a top view of embodiments of a compression ring having a generally annular shape having a raised portion on the upper and lower sides of the outer and inner surfaces of the compression ring.

FIG. 13 is a cross-sectional view of the compression ring of FIG. 12 along line 13-13.

FIG. 14 is a top view of embodiments of a compression ring having a generally annular shape having a raised portion on the upper side of the outer and inner surfaces of the compression ring.

FIG. 15 is a cross-sectional view of the compression ring of FIG. 14 along line 15-15.

FIG. 16 is a top view of embodiments of a compression ring having a generally annular shape having a raised portion on the upper side of the outer and inner surfaces of the compression ring.

FIG. 17 is a cross-sectional view of the compression ring of FIG. 16 along line 17-17.

FIG. 18 is a top view of embodiments of a compression ring having a generally annular shape having a raised portion on the lower side of the outer and inner surfaces of the compression ring.

FIG. 19 is a cross-sectional view of the compression ring of FIG. 18 along line 19-19.

FIG. 20 is a top view of embodiments of a compression ring having a generally annular shape having a raised portion on the upper side of the outer and inner surfaces of the compression ring.

FIG. 21 is a cross-sectional view of the compression ring of FIG. 20 along line 21-21.

FIG. 22 is a top view of other embodiments of a compression ring having a plurality of raised tabs.

FIG. 23 is a cross-sectional view of the compression ring of FIG. 22 along line 23-23.

FIG. 24 is a top view of embodiments of a compression ring having a generally annular shape having generally hour-glass shaped portions on the outer and inner surfaces of the compression ring.

FIG. 25 is a cross-sectional view of the compression ring of FIG. 24 along line 25-25.

### DETAILED DESCRIPTION OF THE PREFERRED EMBODIMENTS

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

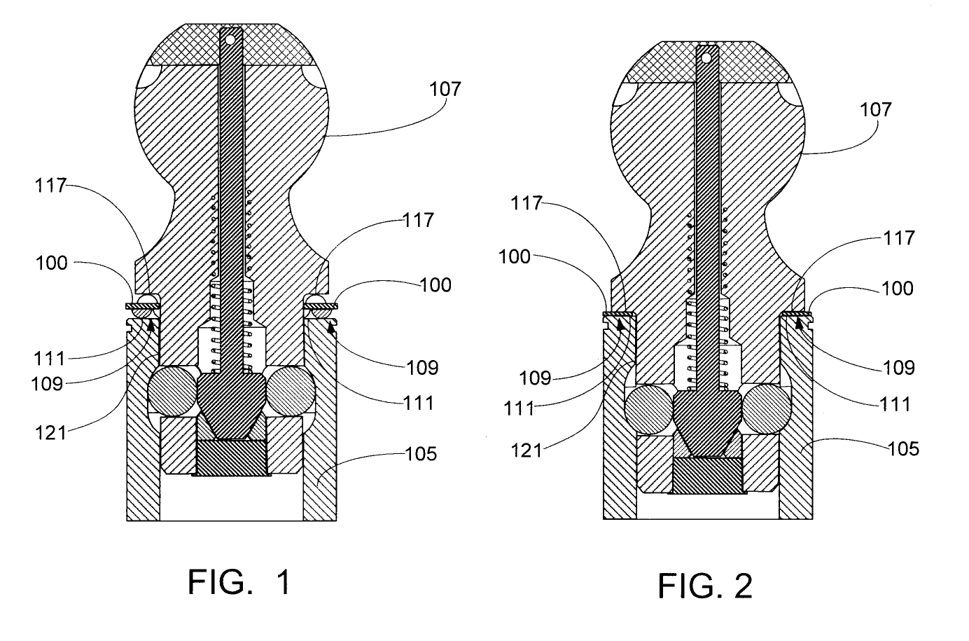

A calibrated overload indicator 100 is shown in FIGS. 1-3. The overload indicator 100 may be selectively positioned in any appropriate location on a towing assembly, such as for example selectively and operatively coupled with an assembled gooseneck hitch assembly 105 and hitch ball 107. The gooseneck hitch assembly 105 may be of any appropriate construction, such as by way of a non-limiting example, the gooseneck hitch assembly 105 may be constructed as described in U.S. Patent Application Publication Number 20100109285, which is hereby incorporated by reference. Further, the hitch ball 107 may be of any appropriate construction. By way of a non-limiting example, the hitch ball 107 may be constructed as shown and described in U.S. Pat. Nos. 8,011,685 and 6,616,168, both of which are hereby incorporated by reference.

In some embodiments, the overload indicator 100 may be selectively positioned between a top surface 109 of a gooseneck collar 111 of the gooseneck hitch assembly and underneath a hitch ball flange 117 of the hitch ball 107. The overload indicator 100 may notify or otherwise indicate to a user that a structural limitation event has occurred, such as by way of a non-limiting example, the towing vehicle being overloaded. By way of a non-limiting example, each axle of a towing vehicle has a vertical force limit, sometimes called the “dynamic limit,” and the overload indicator 100 may be tuned or calibrated to the corresponding limits of a vehicle axle of a particular towing vehicle. When the selected vertical force limit is reached, or surpassed, the overload indicator 100 may indicate this condition, such as by becoming compressed or flattened. In some embodiments, the overload indicator 100 may permanently compress or flatten once the selected vertical force limit is reached or surpassed.

Once compressed or flattened, the flattening of the overload indicator 100 may introduce a vertical gap (or freeplay/slop) in the connection between the hitch ball 107 and the gooseneck hitch assembly 105. Once this vertical gap is present, every vertical variation in a road or driving surface may create a noise as the hitch ball 107 moves within the gooseneck hitch assembly 105. The noise may be generated when the hitch ball 107 moves vertically within a sleeve (not shown) of the gooseneck hitch (not shown) of the towed vehicle, such as by way of a non-limiting example moving ⅜″ to ½″. This noise may act as an indicator that the towing vehicle was or is overloaded and has reached or surpassed its vertical force limit. The noise created due to the flattened overload indicator 100 may be even more pronounced when the towing vehicle travels over rough terrain. By way of a non-limiting example, the flattened overload indicator 100 is shown in FIG. 2.

In some embodiments, the overload indicator 100 may be fit snuggly or have an interference fit with the hitch ball 107. More specifically, the overload indicator 100 may be press fit onto a shank 121 of the hitch ball 107. This may allow the overload indicator 100 to be inspected every time the hitch ball 107 is removed. The overload indicator 100 may be replaced to reset the system either due to the overload indicator 100 being flattened or because of a changing vertical force limit, such as being used a towing vehicle having a load limit on its axle that is different.

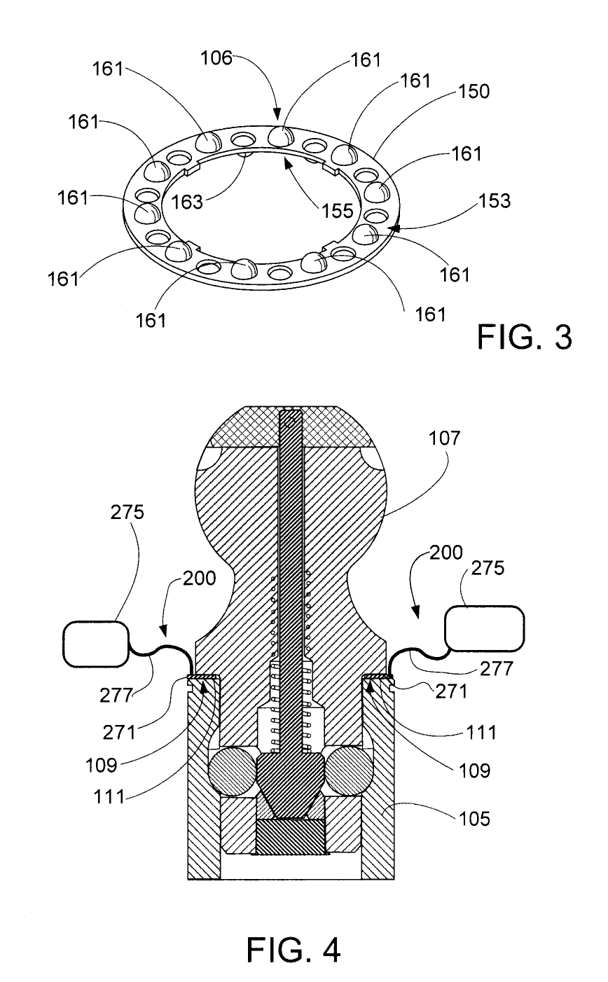

In some embodiments, the overload indicator 100 may include an annular body 150 an example of which is shown in FIG. 3 as an annular ring. The annular ring 150 may be a generally flattened shaped ring that may include a top or first surface 153 and a bottom or second surface 155. The top surface 153 may include a plurality of frangible or crushable indicators 161 such as for example generally hemi-spherically shaped members 161 attached to the top surface 153 of the ring 150. The hemi-spherically shaped members 161 may be attached using fasteners, adhesives, welding, or the like or may be monolithically formed with the ring 150. The bottom surface 155 may include a plurality of crushable or frangible indicators 163 such as for example generally hemi-spherically shaped members 163 attached to the bottom surface 155 of the ring 150. The hemi-spherically shaped members 163 may be attached using fasteners, adhesives, welding, or the like or may be monolithically formed with the ring 150. It should be understood, however, that the shape of the generally hemi-spherically shaped members 161, 163 are exemplary and that any appropriately shaped frangible or crushable member may be used. The overload indicator 100 may be made of any appropriate material, including, without limitation, steel, metal, plastic, polymeric material, a combination of two or more thereof, or any other known material in the art.

In some embodiments, the overload indicator 100 may be about 5 mm to about 30 mm in height. In other embodiments the overload indicator 100 may be about 10 mm to about 20 mm in height. The overload indicator 100 may have a selected compression structure specifically designed or calibrated to flatten or crush when a pre-determined vertical force is applied to the overload indicator 100.

While the overload indicator 100 is shown and described with the gooseneck hitch 105 and hitch ball 107, the overload indicator 100 may be used with other types of towing assemblies. By way of a non-limiting example, the overload indicator 100 may be used with a fifth wheel hitch assembly, a rear mounted hitch assembly (such as a hitch receiver and hitch ball), or the like. Moreover, while the load indicator 100 is shown and described with indicating a generally vertical overload occurrence, the load indicator 100 may also be capable of indicating generally horizontal or combination of vertical and horizontal overload situations, including, without limitation predetermined angular overload situations.

Additional embodiments of an overload indicator according the present teachings are described below. In the descriptions, all of the details and components may not be fully described or shown. Rather, the features or components are described and, in some instances, differences with the above-described embodiments may be pointed out. Moreover, it should be appreciated that these other embodiments may include elements or components utilized in the above-described embodiments although not shown or described. Thus, the descriptions of these other embodiments are merely exemplary and not all-inclusive nor exclusive. Moreover, it should be appreciated that the features, components, elements and functionalities of the various embodiments may be combined or altered to achieve a desired overload indicator without departing from the spirit and scope of the present invention.

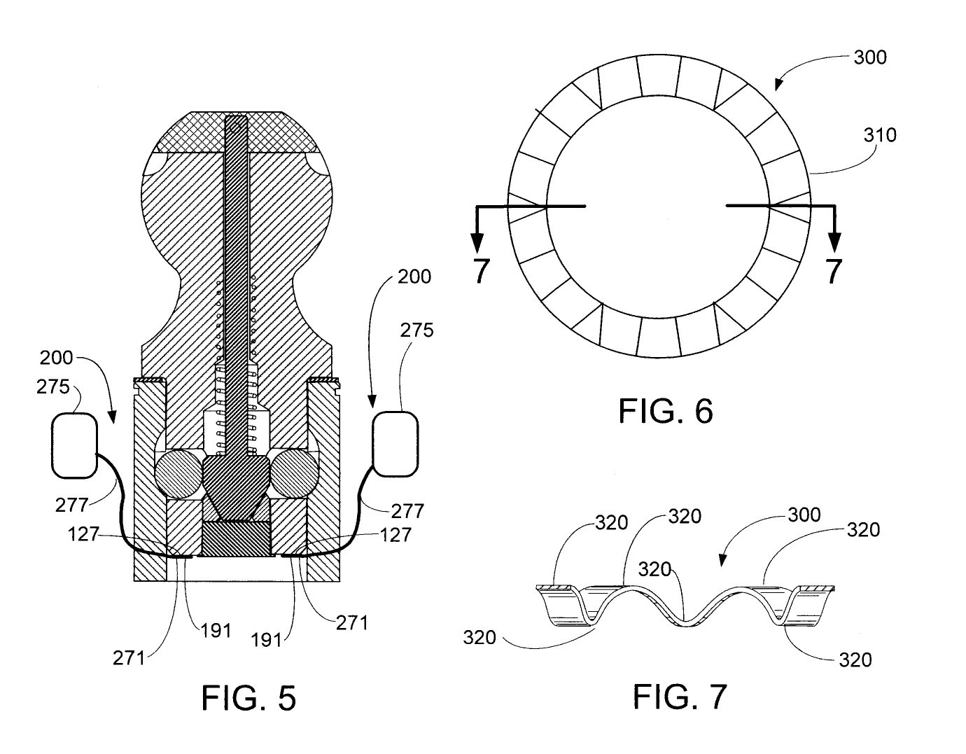

Other embodiments of an overload indicator 200 are shown in FIGS. 4-5. In these embodiments, the overload indicator 200 may include an electronic load cell 271. Any appropriate number of load cells 271 may be used, such as by way of a non-limiting example, one, two, three, etc. The load cells 271 may be selectively positioned in any appropriate position on the gooseneck hitch 105 and/or the hitch ball 107 such that the load cells 271 may measure an amount of vertical load being applied to the gooseneck hitch 105 and/or the axle of the towing vehicle. By way of a non-limiting example, the overload indicator 200 may utilize a pair of load cells 271 that may be positioned opposite one another, i.e., generally about 180 degrees apart.

In these embodiments, the load cells 271 may be operatively coupled with a microcontroller 275 that may be positioned in an appropriate position on the towing vehicle. A wire 277 may be used to operatively couple the load cells 271 with the microcontroller 275. In other embodiments, the load cells 271 may be wirelessly operatively coupled with the microcontroller 275. Further, while each load cell 271 is shown as being operatively coupled to a separate microcontroller 275, a single microcontroller 275 may be used and each of the load cells 271 may be operatively coupled with such microcontroller 275. In other embodiments, the load cells 271 may be operatively coupled with an appropriate electronic system of the towing vehicle, such as by way of a non-limiting example, being operatively coupled to a microcontroller of the towing vehicle.

As shown in FIG. 4, the load cells 271 may be positioned between the top surface 109 of the gooseneck collar 111 of the gooseneck hitch assembly and underneath the hitch ball flange 117 of the hitch ball 107. Still further, while two load cells 271 are shown any number of load cells may be used, including, without limitation, one, two three, etc.

As shown in FIG. 5, the load cells 271 may be positioned between an end portion 127 of the hitch ball 107 and a bottom surface 191 of the gooseneck hitch 105. While the load cells 271 are shown in these positions, the load cells 271 may be in any appropriate position. By way of a non-limiting example, one load cell 271 may be positioned as shown in FIG. 4 and another load cell may be positioned as shown in FIG. 5.

In operation, when an overload condition occurs, the load cells 271 may send a signal to and through the microcontroller 275. A warning system (not shown) may be included in the towing vehicle to alert the operator of such condition. The warning system may be of any appropriate configuration. By way of a non-limiting example, the warning system may include a light, an audible noise, a display or a combination of such. In other embodiments, the towing vehicle may include a display that may receive a signal from the microcontroller 275, which receives a signal from the load cells 271 that may identify the loaded weight. In such embodiments, the operator may use this information to determine if the towing vehicle has reached an overloaded condition. In these embodiments, the microcontroller 275 may be operatively coupled with the towing vehicle controller or the load cells 271 may be operatively coupled directly to the towing vehicle controller, or both. In some embodiments, this may be accomplished through hard-wiring or may be accomplished wirelessly through any appropriate method.

Additional embodiments of an overload indicator are shown in FIGS. 6-15. These overload indicators may generally operate similar to that overload indicator 100 shown and described above. The embodiments described below of the overload indicator may be generally flattened when a predetermine load is exceeded.

In some embodiments, as shown in FIGS. 6 and 7, an overload indicator 300 is shown. The overload indicator 300 may include a compression ring 310 that may include a plurality of waves or undulations 320 that generally extend an entire perimeter or may extend only a portion of the perimeter. As can be seen in the cross-sectional view of FIG. 7, the compression ring 310 may include a plurality of waves or undulations 320 that may compress or flatten at the selected vertical force limit.

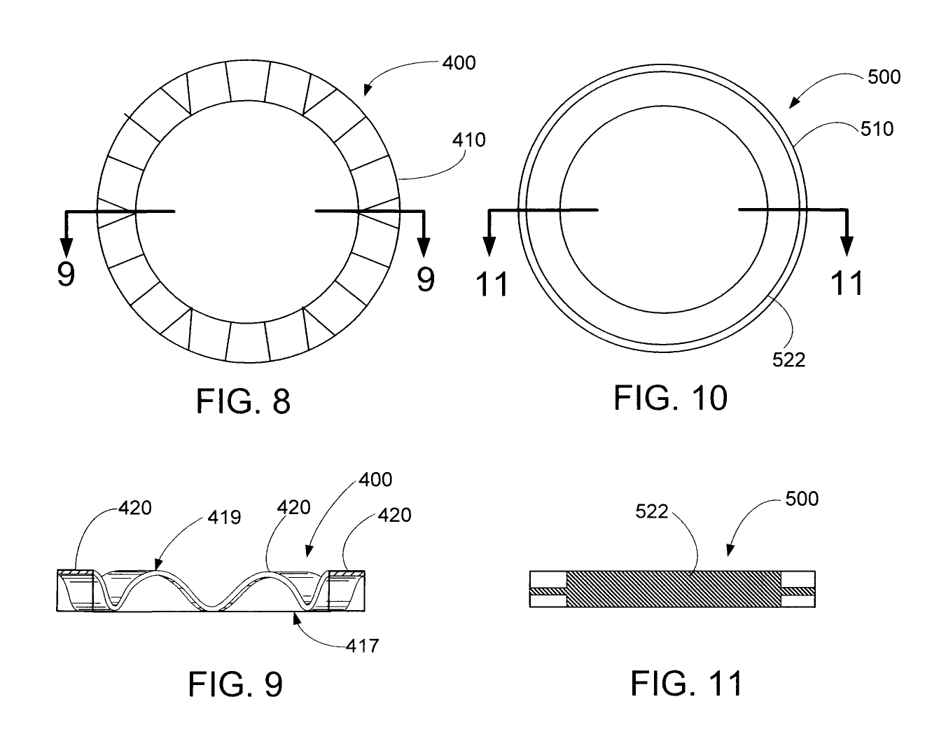

In other embodiments, as shown in FIGS. 8 and 9, an overload indicator 400 is shown. The overload indicator 400 may include a compression ring 410 that may comprise a generally flat lower surface 417 while having an upper surface 419 that may include a plurality of waves or undulations 420. As can be seen in the cross-sectional view of FIG. 9, the compression ring 410 may include a generally flat lower surface 417 while having a plurality of waves or undulations 420 at the upper surface 419. In some embodiments, the waves or undulations 420 may generally extend the length of the perimeter or may extend a portion of the length of the perimeter. Upon reaching the selected vertical force limit, the waves or undulations 420 of the compression ring 410 may compress or flatten.

In other embodiments, as shown in FIGS. 10 and 11, an overload indicator 500 is shown. The overload indicator 500 may include a compression ring 510 that may include a plurality of thin radially oriented ribs 522. As can be seen in the cross-sectional view of FIG. 11, the compression ring 510 may include a plurality of thin radially oriented ribs 522. Upon reaching the selected vertical force limit, the plurality of thin radially oriented ribs 522 of the compression ring 510 may compress or flatten. In some embodiments, the ribs 552 may be annular or circumscribe portions of the compression ring 510.

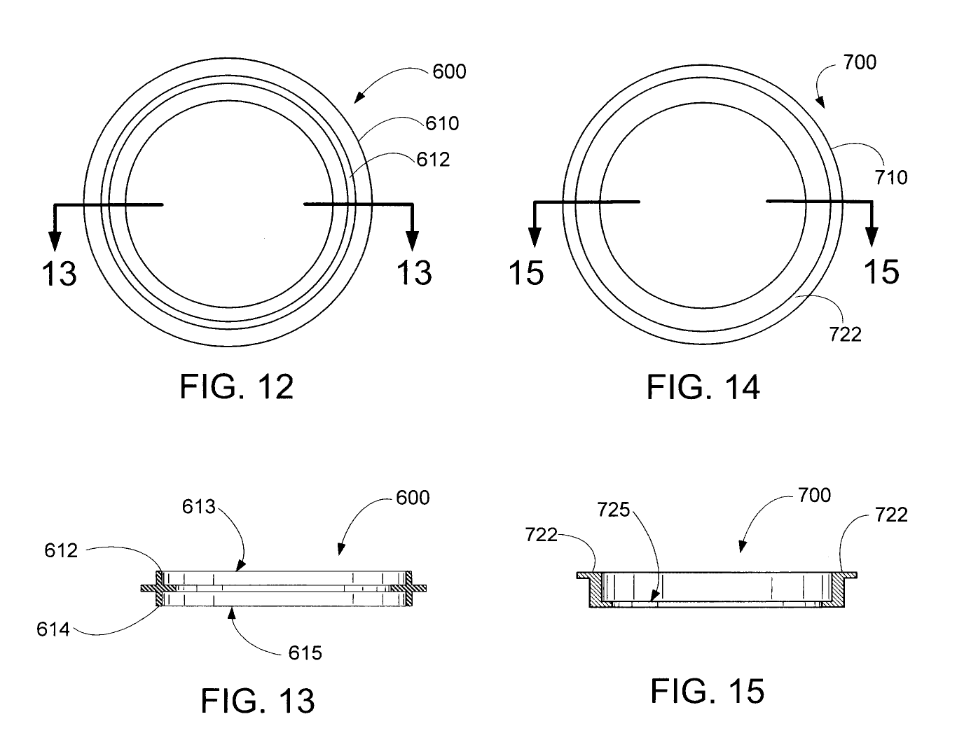

In other embodiments, as shown in FIGS. 12 and 13, an overload indicator 600 is shown. The overload indicator 600 may include a compression ring 610 compression ring that may include a generally annular shape having a raised portion 612 on an upper surface 613 and raised portion 614 on a lower surface 615, see FIG. 13. Upon reaching the selected vertical force limit, the raised upper and lower portions 612, 614 of the upper and lower surfaces 613, 615 of the compression ring 610 may compress or flatten or one of the upper and lower portions 612, 614 may flatten.

In other embodiments, as shown in FIGS. 14 and 15, an overload indicator 700 is shown. The overload indicator 700 may include a compression ring 710 that may include a generally annular shape having a raised portion 722 extending upward from a lower surface 725. As can be seen in the cross-sectional view of FIG. 15, the raised portion 722 of the compression ring 710 may extend annularly outward. Upon reaching the selected vertical force limit, the raised portion 722 of the compression ring 710 may compress or flatten.

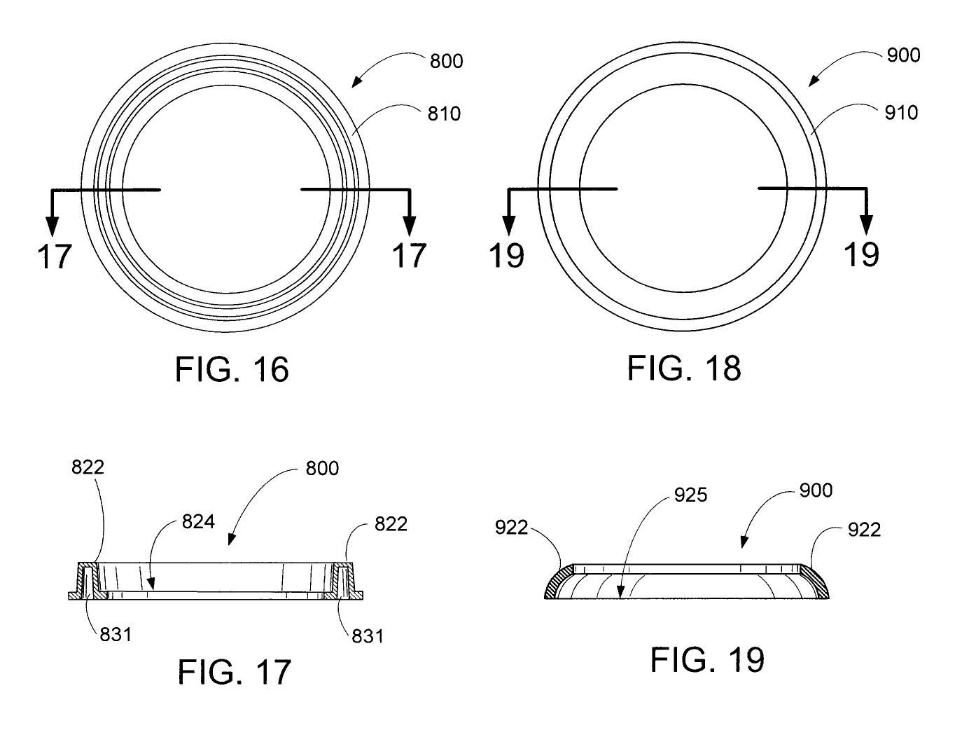

In other embodiments, as shown in FIGS. 16 and 17, an overload indicator 800 is shown. The overload indicator 800 may include a compression ring 810 having a generally annular shape and including a raised portion 822 extending from a lower surface 824 of the compression ring 810. In these embodiments, the raised portion 822 of the compression ring 810 may have a generally pyramidal shaped with a generally hollow core 831. This is shown in more detail in the cross-sectional view of FIG. 17 of the compression ring 810. Upon reaching the selected vertical force limit, the raised portion 822 of the compression ring 810 may compress or flatten, which generally collapses the hollow core 831.

In other embodiments, as shown in FIGS. 18 and 19, an overload indicator 900 is shown. The overload indicator 900 may include a compression ring 910 having a generally annular shape with a raised portion 922 on a lower side 925 of outer and inner surfaces of the compression ring 910. As can be seen in the cross-sectional view of FIG. 19, the compression ring 910 may include the raised portion 922. Upon reaching the selected vertical force limit, the raised portion 922 of the outer and inner surfaces of the compression ring 910 may compress or flatten.

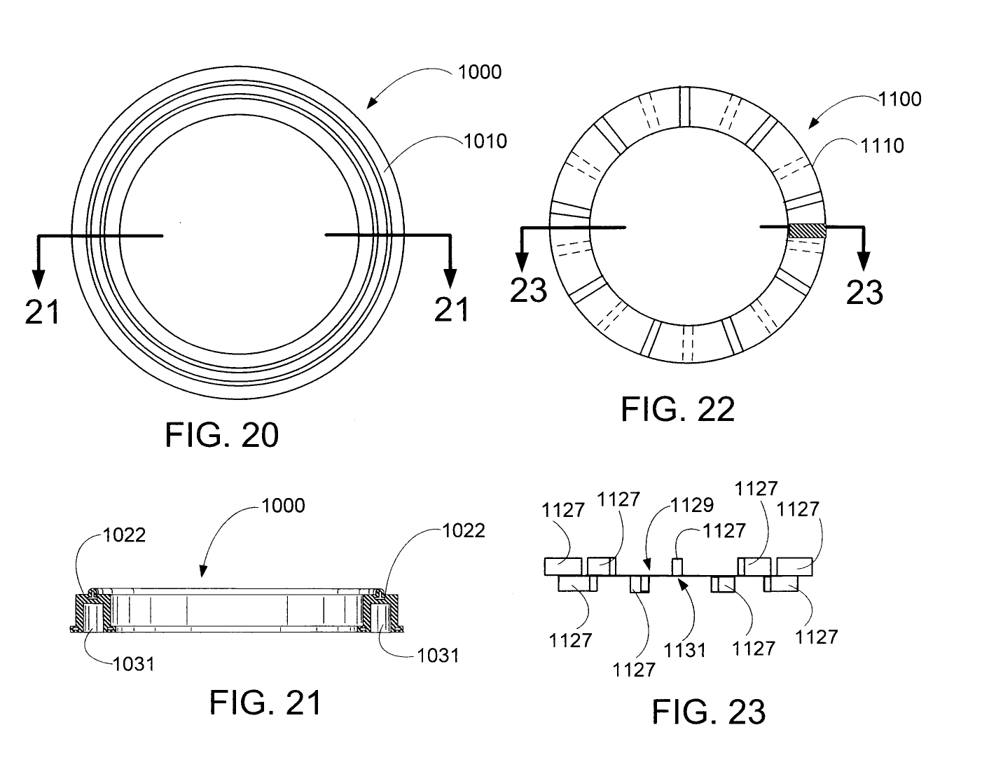

In other embodiments, as shown in FIGS. 20 and 21, an overload indicator 1000 is shown. The overload indicator 1000 may include a compression ring 1010 that may include a generally annular shape having a raised portion 1022 on the upper side of an outer surface of the compression ring 1010. The raised portion 1022 may have a generally polygonal shaped hollow center 1031. This can be seen in more detail in the cross-sectional view of FIG. 21. Upon reaching the selected vertical force limit, the raised portion 1022 of the compression ring 1010 may compress or flatten, which may collapse in the hollow center 1031.

In other embodiments, as shown in FIGS. 22 and 23, an overload indicator 1100 is shown. The overload indicator 1100 may include a compression ring 1110 having a plurality of tabs 1127 that may extend from top and bottom surfaces 1129, 1131 of the compression ring 1110. As can be seen in the cross-sectional view of FIG. 23 tabs 1127 may be of any appropriate shape and size and may be positioned at any appropriate portion of the top and bottom surfaces 1129, 1131. Upon reaching the selected vertical force limit, the tabs 1127 of the compression ring 1110 may compress or flatten.

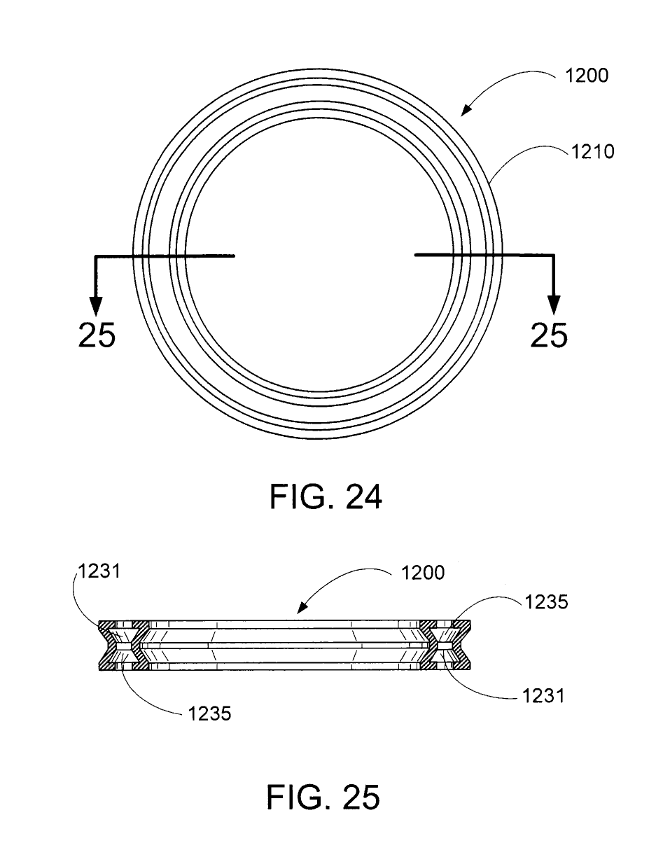

In other embodiments, as shown in FIGS. 24 and 25, an overload indicator 1200 is shown. The overload indicator 1200 may include a compression ring 1210 having a generally annular shape that may include a generally hour-glass shaped portion 1231 on outer and inner surfaces of the compression ring 1210. As can be seen in the cross-sectional view of FIG. 25, the generally hour-glass shaped portions 1231 may include a cavity 1235. Upon reaching the selected vertical force limit, the generally hour-glass shaped portion 1231 of the compression ring may compress or flatten; or more specifically, may generally collapse the cavity 1235.

The features and elements of the embodiments shown and described above may be combined or separately utilized in any appropriate manner. These embodiments may be positioned at any appropriate position on the hitch ball 107 and the gooseneck hitch 105, such as for example as described above. Upon a predetermined load, such as a vertical load, which may be applied to the calibrated overload indicators, such calibrated overload indicators may compress or otherwise flatten. This may then create a predetermined gap between the hitch ball 107 and the gooseneck coupler (not shown) such that an identifiable banging noise may occur, which may indicate an overload situation.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

1-13. (canceled)

14. An overload indicator comprising:
a load cell selectively positioned between a hitch ball and a hitch assembly, wherein the load cell measures a vertical force applied to at least one of the hitch ball and hitch assembly; and
a microcontroller operatively coupled with the load cell, wherein the load cell provides an input signal to the microcontroller indicative of the vertical force measured.

15. The overload indicator of claim 14, further comprising a second load cell selectively positioned between the hitch ball and the hitch assembly, wherein the second load cell measures the vertical force applied to the at least one of the hitch ball and hitch assembly, the second load cell operatively coupled with the microcontroller.

16. The overload indicator of claim 15, wherein the second load cell is positioned opposite the load cell.

17. The overload indicator of claim 14, further comprising a warning device in operative communication with the microcontroller, the warning device adapted to indicate the vertical force measured.

18. The overload indicator of claim 17, wherein the warning device indicates when a force equal to or greater than a selected vertical force limit is applied to the load cell.

19. The overload indicator of claim 18, wherein the warning device consists of one of the following: a light, an audible signal and a display.

20. The overload indicator of claim 18, wherein the warning device is positioned within a cab of a towing vehicle.

21-23. (canceled)

24. An overload indicator comprising:
a load cell adapted to measure a vertical force applied to at least one of a hitch ball and hitch assembly;
a microcontroller operatively coupled with the load cell, wherein the load cell provides an input signal to the microcontroller indicative of the vertical force measured; and
a warning device in operative communication with the microcontroller, the warning device adapted to indicate when the vertical force measured has exceeded a predetermined amount.

25. The overload indicator of claim 24, wherein the load cell is positioned between the hitch ball and hitch assembly.

26. The overload indicator of claim 25, further comprising a second load cell positioned between the hitch ball and hitch assembly, wherein the second load cell measures the force applied to at least one of the hitch ball and hitch assembly, the second load cell operatively coupled with the microcontroller.

27. The overload indicator of claim 26, wherein the second load cell is positioned opposite the load cell.

28. The overload indicator of claim 24, wherein the predetermined amount corresponds to a load limit of the hitch ball, hitch assembly or both.

29. The overload indicator of claim 28, wherein the warning device consists of one of the following: a light, an audible signal and a display.

30. The overload indicator of claim 29, wherein the warning device is positioned within a cab of a towing vehicle.

31. The overload indicator of claim 24, wherein the load cell is adapted to be positioned between a top surface of a gooseneck collar of a gooseneck hitch assembly and below a hitch ball flange of a hitch ball.

32. The overload indicator of claim 24, wherein the load cell is adapted to be positioned between an end portion of a hitch ball and a bottom surface of a gooseneck hitch.

33. An overload indicator comprising:
a load cell adapted to measure a force applied between a hitch ball and hitch assembly;
a microcontroller operatively coupled with the load cell, wherein the load cell provides an input signal to the microcontroller indicative of the force measured and the microcontroller provides an output indicating when the force exceeds a predetermined amount.

34. The overload indicator of claim 33, wherein the load cell is positioned between the hitch ball and hitch assembly.

35. The overload indicator of claim 33, wherein the force measured is a vertical force.

36. The overload indicator of claim 33, further comprising a warning device in operative communication with the microcontroller, the warning device adapted to indicate when the force applied to the load cell is equal to or greater than a selected force limit.
